(19) United States
(12) Patent Application Publication
(10) Pub. No.: US 2026/0111923 A1
(43) Pub. Date: Apr. 23, 2026

(54) Automated Machine Learning Based Hotel Room Pricing

(71) Applicant: Oracle International Corporation, Redwood Shores, CA (US)

(72) Inventors: Andrew VAKHUTINSKY, Sharon, MA (US); Kirby BOSCH, Ann Arbor, MI (US); Svetlana RIABOVA, Buffalo, NY (US); Zuxuan HUAI, New York, NY (US); Boro PETROVIC, Naples, FL (US); Jason G. BRYANT, Las Vegas, NV (US); Natalia KOSILOVA, Burlington, MA (US)

(21) Appl. No.: 19/050,410

(22) Filed: Feb. 11, 2025

Related U.S. Application Data
(60) Provisional application No. 63/710,050, filed on Oct. 22, 2024.

(51) Int. Cl. G06Q 30/0201; G06N 20/00; G06Q 10/02; G06Q 10/04; G06Q 30/0283; G06Q 50/12

(52) U.S. Cl. CPC G06Q 30/0206; G06N 20/00; G06Q 10/02; G06Q 10/04; G06Q 30/0284; G06Q 50/12

(57) ABSTRACT

Embodiments optimize hotel room pricing by generating a causal model including an estimate of a causal effect of a hotel room price on a demand of the hotel room. Embodiments receive historical hotel room reservation data and select one of a plurality of predictive models based at least on the causal model. Embodiments then map the price of the hotel room to the demand of the hotel room.

### CROSS REFERENCE TO RELATED APPLICATIONS

This application claims priority to U.S. Provisional Patent Application Ser. No. 63/710,050, filed on Oct. 22, 2024, the disclosure of which is hereby incorporated by reference.

### FIELD

One embodiment is directed generally to a computer system, and in particular to a computer system implementing machine learning hotel room pricing.

### BACKGROUND INFORMATION

Revenue management is the process of dynamically adjusting prices of goods or services in response to changes in market conditions or changes in supply conditions. Revenue management processes were pioneered by the passenger airline industry and have been imitated by other industries such as cargo airlines, hotels, car rentals, shippers, advertisement brokers, etc.

A very common application of revenue management relates to service providers who are taking reservations for “date-constrained services”. Date-constrained services involve the imposition of transaction-specific limits on the date when the buyer may use the services they purchase. Examples of such a restrictions include specified arrival and departure dates for an airline reservation as well as specified check-in and check-out dates for a hotel reservation. The time restrictions make it particularly difficult to estimate demand and then determine optimized pricing that maximizes revenue/profit for date-constrained services, particularly in the hotel industry.

### SUMMARY

Embodiments optimize hotel room pricing by generating a causal model including an estimate of a causal effect of a hotel room price on a demand of the hotel room. Embodiments receive historical hotel room reservation data and select one of a plurality of predictive models based at least on the causal model. Embodiments then map the price of the hotel room to the demand of the hotel room.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 is an overview block diagram of a hotel reservation system in accordance to embodiments of the invention.

FIG. 2 is a block diagram of a computer server/system in accordance with an embodiment of the present invention.

FIG. 3 is a flow/block diagram of the functionality of the automated pricing module of FIG. 2 when automating and optimizing prices in accordance to embodiments.

FIG. 4A illustrates causal effect for a demand generating process, and FIG. 4B illustrates an intervention on price for the causal effect in accordance to embodiments.

FIG. 5 illustrates an example causal model that can implement the causal model of FIG. 3 in embodiments.

FIG. 6 presents examples of back-door paths from the causal model of FIG. 5 in accordance to embodiments.

FIG. 7 provides an example of counterfactual predictions using a Random Forest model in accordance to embodiments.

FIG. 8 illustrates the graphical structure of the Double ML graphical structure model in accordance to embodiments.

FIG. 9 illustrates historical prices and double ML estimates in accordance to embodiments.

FIGS. 10-13 illustrate an example cloud infrastructure that can implement the hotel chain operations that can include the automated pricing system of FIG. 1 in accordance to embodiments.

### DETAILED DESCRIPTION

Embodiments are directed to a prescription analytics model that functions as the main engine of an automated room pricing system for hotels. The model produces pricing recommendations by solving a revenue maximization problem. The main challenge in solving this optimization problem is that the demand is not a known function of the decision variable, but instead needs to be estimated from historical data. Embodiments include two parts: a causal predictive model for estimating demand at a given price and a price optimization model which embeds it.

Embodiments provide optimal pricing recommendations. These recommendations are obtained as an optimal solution to the optimization problem which maximizes the revenue. The revenue is given by the product of price (p) and demand (d) expected at that price (i.e., p*d(p)). Embodiments recognize that a prediction model alone cannot be used for demand, since prediction models only capture associations presented in the data. A prediction model can answer the question “What would the demand be observed the price p?” which implies that there is an underlying demand-generating process, and by observing new values for the factors which affect the demand the demand itself can be predicted given that the demand-generating process does not change. Optimization, on the other hand, can be viewed as a virtual intervention, which is equivalent to asking the question “What would the demand be if the price is set to be p?”. That removes any influence the other factors may have on the price and sets it to a certain value regardless of the values that the other variables in the system assume.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

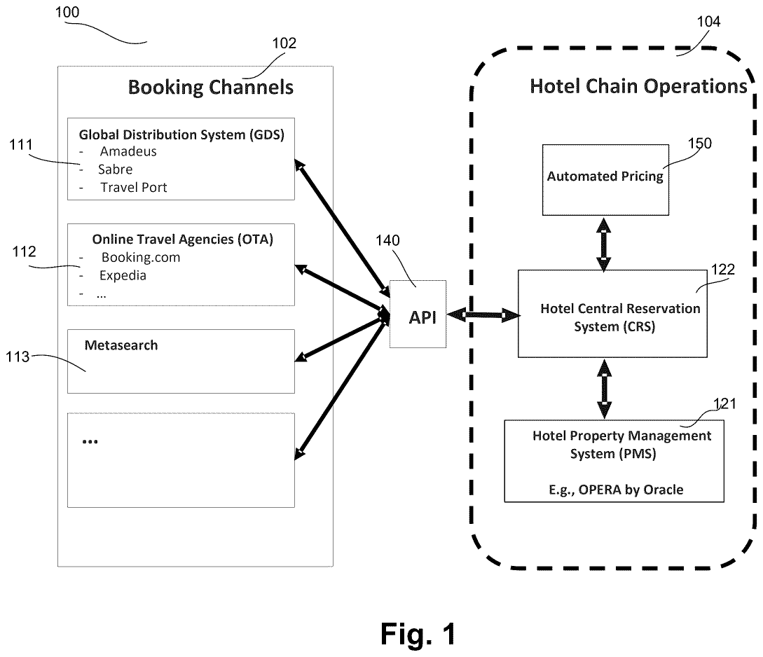

FIG. 1 is an overview block diagram of a hotel reservation system 100 in accordance to embodiments of the invention. FIG. 1 includes booking channels 102 that a potential hotel customer may interact with to reserve a hotel room. The channels include a Global Distribution System (“GDS”) 111, including “Amadeus”, “Sabre”, “Travel Port”, etc., Online Travel Agencies (“OTA”) 112, including “Booking.com”, “Expedia”, etc., Metasearch sites 113, and any other means for a customer to reserve a hotel room, including a website maintained by a hotel chain or individual hotel.

Each hotel chain operations 104 is accessed by an Application Programming Interface (“API”) 140 as a Web Service such as a “WebLogic Server” from Oracle Corp. Hotel chain operations 104 includes a Hotel Property Management System (“PMS”) 121, such as “OPERA Cloud Property Management” from Oracle Corp., a Hotel Central Reservation System (“CRS”) 122, and an Automated Pricing system 150 that interfaces with systems 121 and 122 to provide automated pricing, and all other functionality disclosed herein. In embodiments, hotel chain operations 104 is implemented by a cloud based infrastructure. In one embodiment, the cloud based infrastructure comprises the “Oracle Cloud Infrastructure” (“OCI”) from Oracle Corp.

A hotel customer or potential hotel customer that uses system 100 to obtain a hotel room typically engages in a three stage booking process. First an area availability search is conducted. Multiple hotel chains are shown and hotel CRS 122 provides static data. The static data can include the min/max rate, available dates, etc.

If the booking customer selects a hotel, they go to the next step which is the property search, including a single hotel property, multiple rooms and rate plans. For the single hotel property, information may include room category description data, rate plan description and room price, each of which is shown in a specific order. The property search includes real-time availability data and results in the booking customer selecting a room. Once the room is selected, the final step is final booking and the reservation being guaranteed by a credit card or other form of payment.

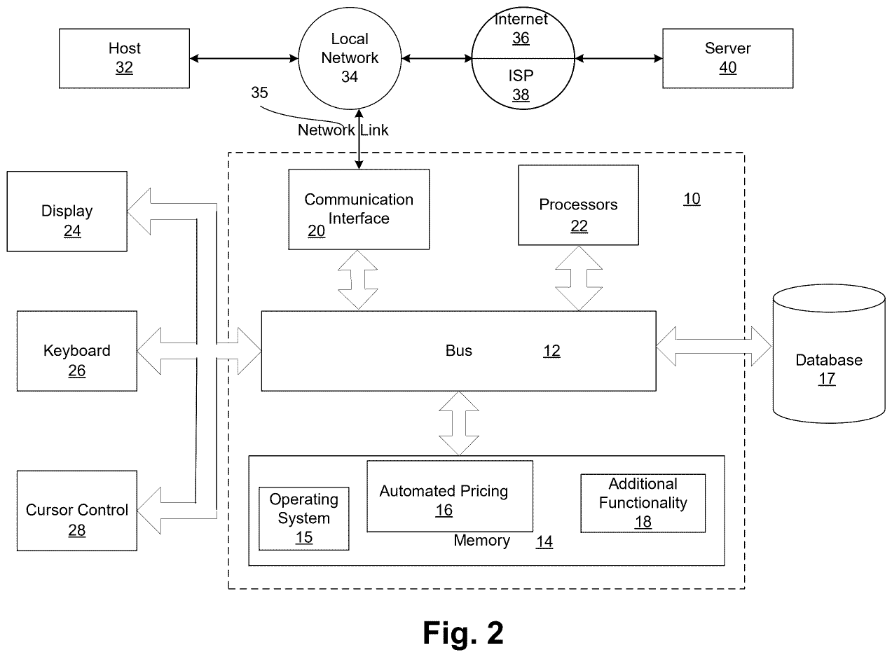

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, when implemented as a web server or cloud based functionality, system 10 is implemented as one or more servers, and user interfaces such as displays, mouse, etc. are not needed. In embodiments, system 10 can be used to implement any of the elements shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include automated pricing module 16 that automates pricing for date constrained inventory, such as hotel rooms. System 10 can be part of a larger system. Therefore, system 10 can include one or more additional functional modules 18 to include the additional functionality, such as the functionality of a Property Management System (“PMS”) (e.g., the “Oracle Hospitality OPERA Property” or the “Oracle Hospitality OPERA Cloud Services”) or an enterprise resource planning (“ERP”) system. A database 17 is coupled to bus 12 to provide centralized storage for modules 16 and 18 and store guest data, hotel data, transactional data, etc. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 800, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

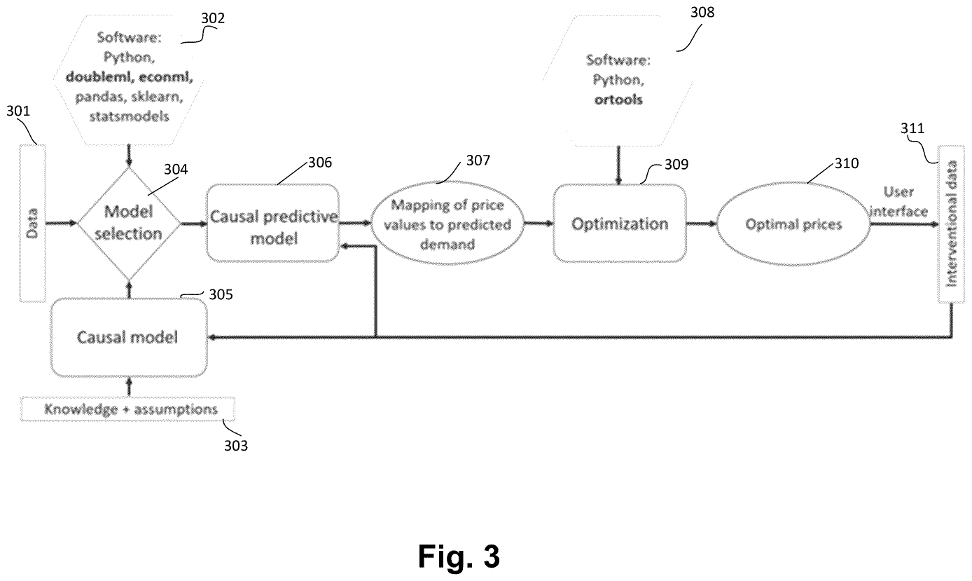

FIG. 3 is a flow/block diagram of the functionality of automated pricing module 16 of FIG. 2 when automating and optimizing pricing in accordance to embodiments. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. The functionality of FIG. 3 is disclosed for a hotel reservation system, but in other embodiments can be adapted to any date-constrained environment.

In general, embodiments perform automated pricing recommendations for hotel rooms. The generated optimal prices 310, for multiple hotel room categories (i.e., basic, premium, suite, etc.), maximize revenue for a single property, multiple properties (e.g., hotel chain), or maximize some other objective function (e.g., profit, etc.). The recommendations are aimed at maximizing the objective function and incorporate an optimization module 309. A technical challenge in solving this optimization problem is that the demand is not a known function of the decision variable but instead needs to be estimated from historical data 301.

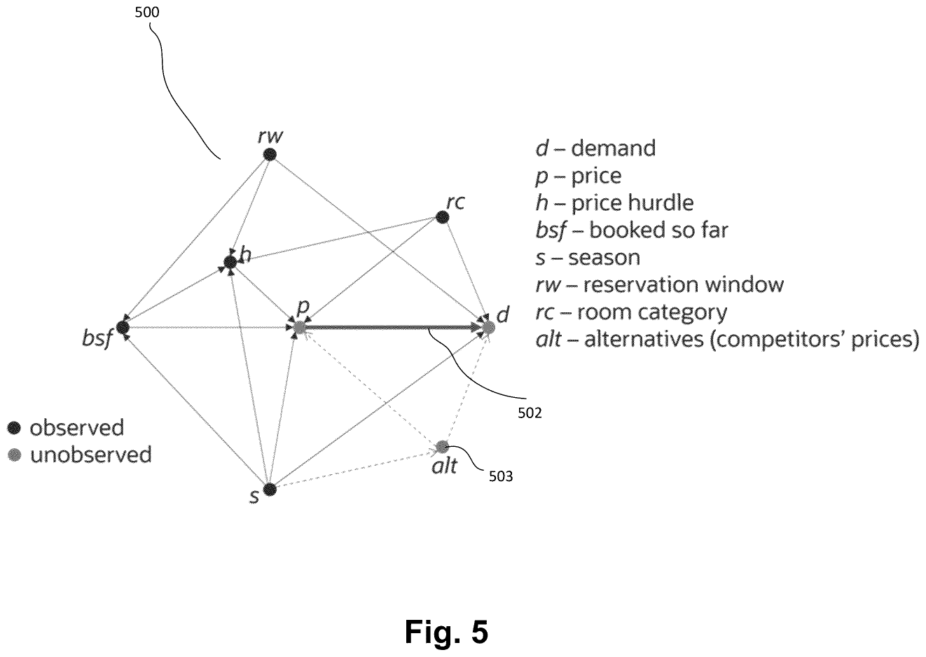

Initially, in embodiments, a causal model 305 is constructed/trained based on the domain/general knowledge and predetermined simplifying assumptions 303. Examples of such domain knowledge include the description of the current price-setting mechanism which determined the confounding factors that affected the price and the demand in the historical data (i.e., the incoming arrows into “p” in FIG. 5), the prior knowledge on the historical demand-generating process (e.g., the fact that certain holidays affect the demand at specific locations), and the knowledge of which alternatives are usually available to the customer at the time of booking.

Causal model 305 provides guidance to determine an estimate of the causal effect of the price on the demand (i.e., determines a set of features to include in predictive model 306). Then, a statistical estimation of the price effect that is informed by causal model 305 is performed as part of a model selection 304 function in response to historical data 301. In embodiments, the historical data 301 is received from a property management system, such as PMS 121 of FIG. 1. At 304, embodiments test multiple trained statistical models and select one of them (i.e., selected causal predictive model 306) based on the dataset specifics. Once the relationships in the historical data-generating process have been determined in the causal model at 305, a statistical model can be used to estimate the price effect provided a sufficient amount of data is available. Due to the practical limitations concerning data quality and amount, embodiments compare several models, such as linear regressions, random forests and specialized causal machine learning models and methods such as double machine learning and causal forests.

Causal predictive model 306 (created by double machine learning (“ML”) or other choice of models and selected from a choice of models at 304) determines the estimate of the causal effect from the guidance at 305. In embodiments, the final model selection is performed by the statistical assessment of the quality of fit which can include a combination of metrics such as p-values for the regression coefficients, R², MAPE, and analysis of model residuals. Once the best model is selected and trained, its parameters are fixed and it is used to determine the optimal prices at 309. Additional model training may be performed after some amount of new data is collected. In general, it is beneficial to either update the model parameters with a certain frequency which would depend on the particular application or introduce a continuous update scheme so the latest data is always incorporated in the model's decisions to account for external changes in the demand-generating process.

The estimate from model 306 yields a price-demand relationship/mapping 307 that can be used to determine the result of changing/manipulating the price. Once the features are determined to be used in the model, in one embodiment, as disclosed below, estimation (i.e., mapping) is performed using doubleML. Mapping 306 is provided by the fitted predictive model. At 309, the obtained price-demand relationship 307 is embedded in a revenue-maximizing optimization problem and the optimal set of prices are determined at 310 (i.e., optimal prices for different classes of hotel rooms). In one embodiment, at 308, “OR-Tools” from Google Corp. is used to implement price optimization 309. Implementing these optimal prices, in response to a user selection of prices that are presented as selectable prices in a user interface provides new interventional data or feedback data 311 that can be used to refine and re-train both the causal model 305 and the statistical estimate 306 in a reinforcement learning fashion.

In embodiments, the optimal prices are obtained at 310 by embedding the selected statistical model into a revenue-maximization problem. If the best-performing model is a linear regression, the embedding is relatively simple as the linear expression with the estimated regression coefficient substitutes the demand in the objective function p*d(p, X). For non-parametric models such as tree ensembles, embodiments use known embedding methods as follows: The structure of each tree in the ensemble is encoded in the optimization problem using binary variables to represent the branching of the trees. In that case, for each candidate solution, these encoded tree structures trace the decision path of the trained predictive model and the linear expression that represents the combined predictions of the trees is plugged into the objective function.

Further, in response to a user selecting or otherwise being assigned a price optimized specific room, embodiments include transmitting specialized data (i.e., data specific to the selected room) to other specialized devices that use the data, such as using the data to automatically encode hotel room keys, using the data to automatically program hotel room door locks, etc.

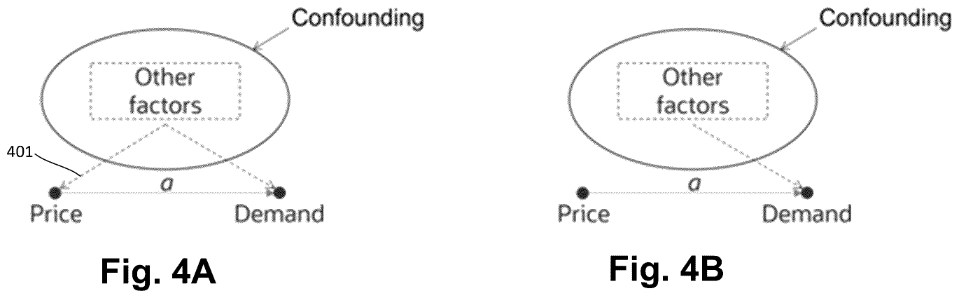

FIG. 4A illustrates causal effect for a demand generating process, and FIG. 4B illustrates an intervention on price for the causal effect in accordance to embodiments. Embodiments solve the potential problems and shortfalls of using a prediction model for demand, since prediction models only capture associations presented in the data. They are able to answer the question “What would the demand be if the price p is observed?” which implies that there is an underlying demand-generating process, and by observing new values for the factors which affect the demand the demand itself can be predicted given that the demand-generating process does not change, as indicated by link 401 in FIG. 4A between the “other factors” and the price. Optimization, on the other hand, can be viewed as a virtual intervention, where the question is “What would the demand be if the price is set to be p?”. That is, all the links are removed from other factors to the price and the price is set to a certain value regardless of the values that the other variables assume, as shown in FIG. 4B.

### Causal Model 305

To be able to answer such interventional questions, there is need to estimate the direct causal effect of price on demand, which is indicated as “a” in FIGS. 4A and 4B. Embodiments estimate this effect using causal model 305. Causal model 305 allows embodiments to predict the result of an intervention from the intervention-free data.

FIG. 5 illustrates an example causal model 500 that can implement causal model 305 in embodiments. Link 502 represents the causal effect of interest (i.e., between price and demand). Some embodiments are concerned with making a pricing decision for a particular room at a particular date. Model 500 includes the following features that affect the demand-generating process: room category (“rc”); reservation window (“rw”), which is how far in advance a booking is made; booked-so-far (“bsf”), which is how many rooms in the considered category are already booked for the considered date at the present moment; seasonality features (“s”); and price hurdle (“h”), which represents the lower bound on the rates offered and is just a historical mechanism for price regulation in the data. Embodiments include an alternative feature 503 (“alt”) which is connected to the rest of the diagram with punctured arrows. Alternative feature 503 is a feature carrying information on alternative options available on the market, such as competitors' prices. For example, there may be a strong reason to believe that this feature affects the demand, but at the same time embodiments may not have historical observations on its values.

In order to be able to identify the causal effect of price on the demand, embodiments first block all non-causal flows of information, referred to as “back-door” paths (i.e., causal inference theory). Embodiments close back-door paths by controlling for appropriate variables. Embodiments block any back-door paths between the price and the demand because these paths can produce spurious correlations in the data but do not carry any causal information. To remove this effect of confounding, embodiments adjust for each level of the identified confounders automatically when a regression hyperplane is fitted on price and the confounding variable needed to be adjusted for. In small causal models, the back-door paths can be examined manually and variables needed for adjustment can be also identified by hand. In larger causal models, multiple available “identification” based algorithms can be used to automatically find the set of variables to be controlled for.

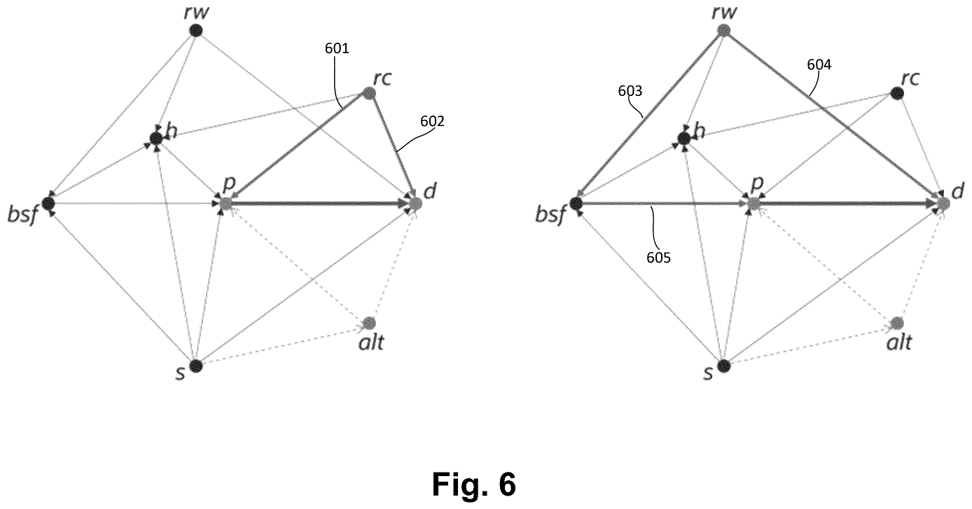

FIG. 6 presents examples of back-door paths from causal model 500 of FIG. 5 (indicated at links 601-605) in accordance to embodiments. In each figure, the showcased back-door path and the variable that needs to be controlled for in order to close are shown. As shown in the example of FIG. 6, it can be determined that it is sufficient to control for room category, reservation window and season to de-confound the price effect.

### Predictive Causal Demand Model 306

In embodiments, predictive causal demand model 306 is implemented as a one-product case, meaning that only the price is considered for the room category under consideration. However, embodiments can be extended to the multi-product case for which there is a need to make estimations of multi-treatment effects modeled as cross-elasticities in the linear case.

In general, it is assumed that the demand can be described by a function of price, d(p), with the following properties:
1. d(p) is strictly decreasing in p;
2. d(p) is continuously differentiable on the domain of p;
3. d(p) is bounded above and below;
4. d(p) tends to 0 for sufficiently high values of p.
   Embodiments adopt a log-linear demand model that has the following form:

$$d ( p , X ) = {e}_{- βρ + g ( X )} \qquad ( 1 )$$

where X represents a vector of the covariates (other than price) that affect the demand. Equivalently, in logarithmic form,

$$log d ( p , X ) = - β p + g ( X ) \qquad ( 2 )$$

This function can be estimated using, for example, a linear regression when taken in its logarithmic form for both one- and multi-product cases assuming X is also in a linear relationship with d. Equation (2) is referred to as a “partially linear regression” (“PLR”).

In the one-product embodiment, the unconstrained optimization problem that maximizes the revenue R(p,X)=p*d(p,X) where d(p,X) is given by (1) has a closed form solution:

$${p}^{*} = \frac{1}{β} \qquad ( 3 a )$$

$$R ( {p}^{*} , X ) = {p}^{*} {e}^{- β {p}^{*} + g ( X )} \qquad ( 3 b )$$

As disclosed, at 304, a selection of a type of predictive model out of a plurality of different predictive models is selected. In other embodiments, a single type of predictive model can always be used, so that the selection at 304 is not needed. In one embodiment, three different approaches to price sensitivity estimation, or three different types of predictive models, are considered. In embodiments, the first naive approach is estimation with Linear Regression. It includes making rather restrictive assumptions about the functional form for g(X). Another approach is a Random Forest to estimate the joint non-linear effect of p and X. Both of these approaches do not perform well in the presence of endogeneity. The last estimation approach used in embodiments is estimation with Double/Debiased ML, which allows endogeneity to be explicitly modeled and removes regularization and overfitting biases when using complex ML models.

In all possible models, embodiments make necessary adjustments to account for the heterogeneous treatment effect as price sensitivity is assumed to vary by room category, reservation window and season. In embodiments, one or more of the following models are used, with model selection 304 implemented when more than two models are used:

### Linear Regression

In theory, given a sufficiently large enough data sample, running an ordinary least squares (“OLS”) regression would be a plausible way of estimating price sensitivity β. However, given a limited amount of data and high-dimensional covariates (e.g., binary seasonality features), embodiments to employ regularization techniques to avoid overfitting.

Embodiments perform the estimation in two steps. The first one is running a regularized Lasso regression on p, X and some interaction terms between the features. This step performs feature selection. Embodiments then run an OLS regression with the selected features plus the price lifts (i.e., interactions with price) for room categories and selected seasonality features, which are used to account for the heterogeneous treatment effect.

### Random Forest

Random forests are a non-parametric method and they cannot be used to explicitly estimate price sensitivity as a coefficient in a PLR. Instead, embodiments estimate a non-linear function f(p,X) and use the corresponding demand function d(p,X)=e^{f(p,X)} for price optimization. The corresponding revenue-maximization problem in this case does not have a closed-form solution but can be solved by embedding the trained Random Forest model in it.

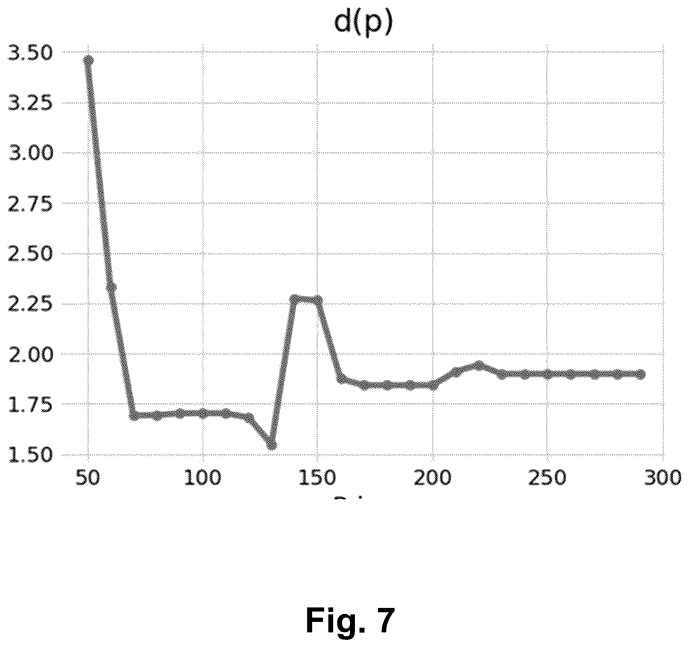

In one embodiment a “scikit-learn” RandomForestRegressor is trained with 50 trees, a minimal leaf size of 15 and a maximum depth of 10. Embodiments use this model to do a counterfactual analysis within the historical price range on several test rows. FIG. 7 provides an example of counterfactual predictions using a Random Forest model in accordance to embodiments. As can be seen from the plot of FIG. 7, the resulting function does not satisfy the regularity conditions disclosed above. The demand is non-monotonic and has a heavy tail in the higher price range. The primary reason is the presence of endogeneity. Hotel pricing is known to rely on a lot on factors, such as season, reservation window and the number of rooms already booked. For random forest, it means that the price can be explained reasonably well with the other covariates in the model and does not carry much additional information given the other features so the trees choose to disregard it in favor of other covariates. Further, embodiments employ regularization techniques for both linear regression and random forest models and regularization is known to inflict a bias on treatment effect estimates shifting them towards zero.

### Double ML

DoubleML, in general, is a framework designed for the application of machine learning methods to causal inference and treatment effect estimation. It extends the principles of orthogonalization and sample-splitting to ensure that machine learning models can be used for valid statistical inference in scenarios with high-dimensional covariates. DoubleML focuses on estimating treatment effects or causal parameters while accounting for potential confounding effects. Machine learning models are used to flexibly model complex relationships, such as between covariates and outcomes. DoubleML uses a technique called orthogonalization (or Neyman orthogonal scores) to reduce bias introduced by the use of machine learning estimators. This involves creating a debiased score function that isolates the parameter of interest. To avoid overfitting and to maintain valid inference, DoubleML incorporates sample-splitting. This means one part of the data is used to train machine learning models (e.g., for nuisance parameter estimation), and another part is used for inference. Nuisance parameters, such as the propensity score (probability of treatment assignment) and conditional expectations, can be estimated using any suitable machine learning algorithms (e.g., random forests, gradient boosting, or neural networks).

In the Double ML approach, embodiments extend the PLR with a second model that describes p in terms of X. This way, the model specification is given by:

$$log D = - β D + g ( X ) + U \qquad ( 4 a )$$

$$P = m ( X ) + V \qquad ( 4 b )$$

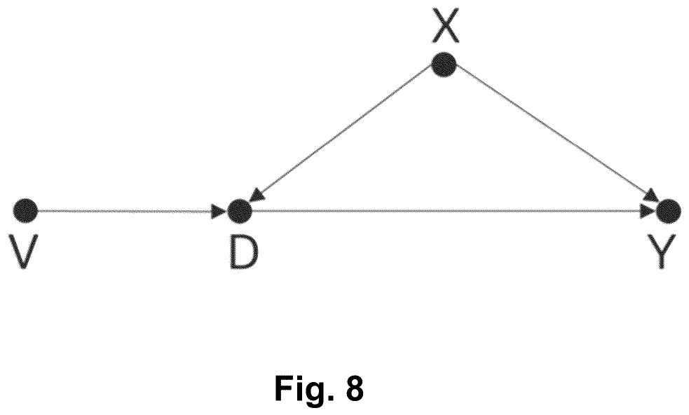

FIG. 8 illustrates the graphical structure of the Double ML graphical structure model in accordance to embodiments. It resembles the instrumental variable design widely used in econometric studies. Instrumental variables are a powerful tool for causal effect estimation in a setting where there is no way to close all the back-door paths connecting the treatment and the outcome. Natural instruments are also notoriously hard to find or engineer. In the above model of 4a and 4b, embodiments can treat the price residuals V as an artificial instrument and perform a two-stage estimation.

Double ML is based on the ideas of orthogonalization and sample-splitting, which allow removing the regularization and overfitting bias from the treatment effect estimates in the presence of high-dimensional confounders. In general, embodiments split the data into two samples and use the first one to fit arbitrary ML models for E[D|X]=−βm(X)+g(x) and E[P|X]=m(X), then use the second sample to calculate the orthogonalized demand and price (residuals of the first-stage models) and estimate the treatment effect using linear regression.

### Nuisance Models

Embodiments use nuisance models to estimate E[D|X] and E[P|X]. A nuisance model is a part of the double ML model at 302. The two-stage double ML estimation includes (1) an orthogonalization step, which estimates the effect of confounders on demand and price (done by two nuisance models) and removes these effects to obtain orthogonalized residuals; and (2) a causal effect estimation on orthogonalized data.

Embodiments attempted to fit both functions with linear regression and random forest models and found that linear regression gives a better fit for prices while random forest tends to perform slightly better for demand. In embodiments, the final model metrics for price were R²=0.81 and MAPE=0.22 on a test set which suggests high endogeneity. The demand model metrics were R²=0.59 and MAPE=0.72 on the test set. The demand model metrics are substantially worse than those of the price model which might indicate the limitation of the feature engineering but also might be attributed to the fact that this demand model estimates E[D|X] and that there is the residual component of price, V, which is omitted.

### Price Effect

Embodiments implement the “doubleml” Python package to obtain the final price effect estimates. Embodiments estimate the group average treatment effects (“GATE”s) for groups defined by room category and month of the year.

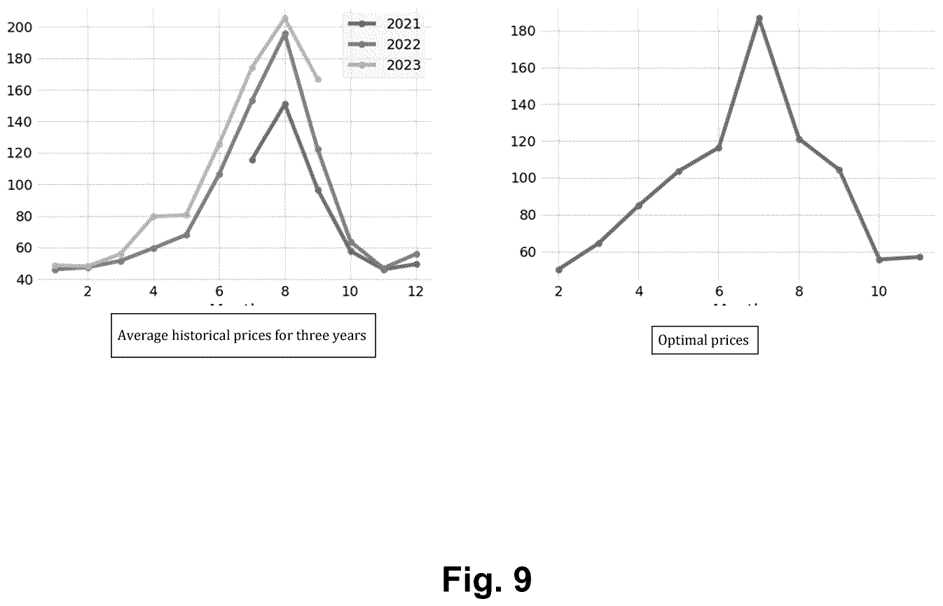

FIG. 9 illustrates historical prices and double ML estimates in accordance to embodiments. FIG. 9 shows an example of how the optimal prices calculated based on the obtained heterogeneous price sensitivity estimates compare to the average historical prices.

### Multiple Prices

Embodiments also consider an extended model, which allows cross-effects to be accounted for between prices for different room categories and release the assumption of their independence. The demand function in this case takes the following form:

$$log d ( p , X ) = - {β}^{T} p + g ( X ) \qquad ( 5 )$$

where p is a vector of prices for different room categories. In linear and partially linear models, these effects can be estimated as cross-sensitivities between the categories, in which case the function takes the following form:

$$log d ( {p}_{0} , p , X ) = {β}_{0} {p}_{0} - {β}^{T} p + g ( X ) \qquad ( 6 )$$

where β₀ is the main price sensitivity for the category under consideration and β is the vector of lift coefficients that represent the relative effect of other categories' pricing.

### Example Cloud Infrastructure

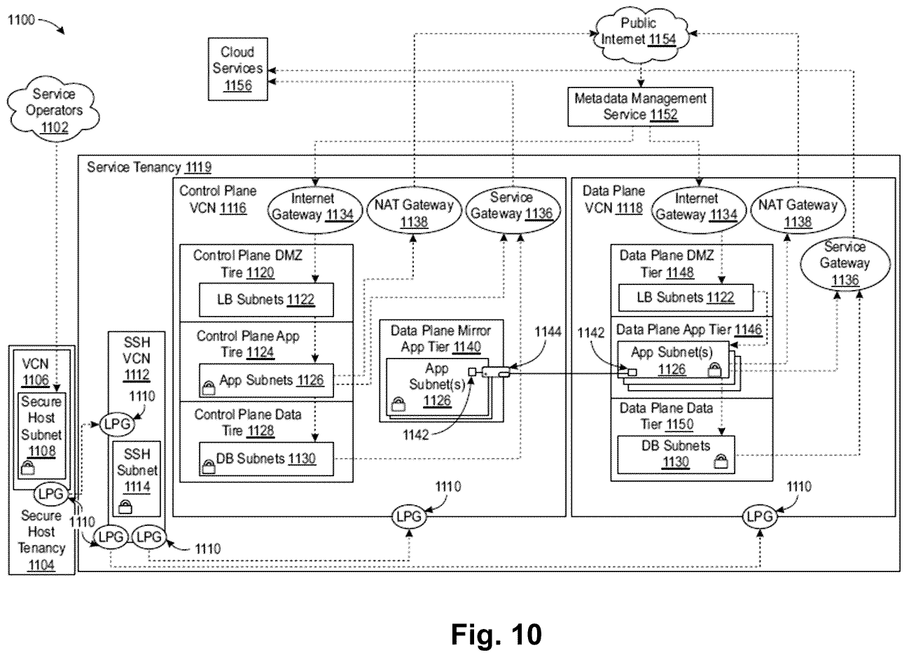

FIGS. 10-13 illustrate an example cloud infrastructure that can implement hotel chain operations 104 that can include automated pricing system 150 of FIG. 1 in accordance to embodiments.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS”s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 10 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

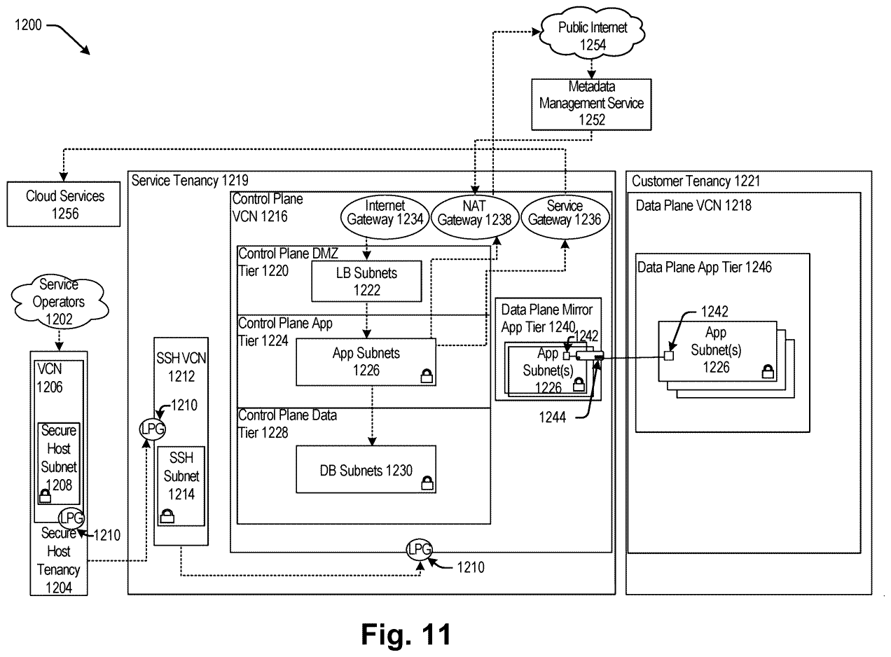

FIG. 11 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

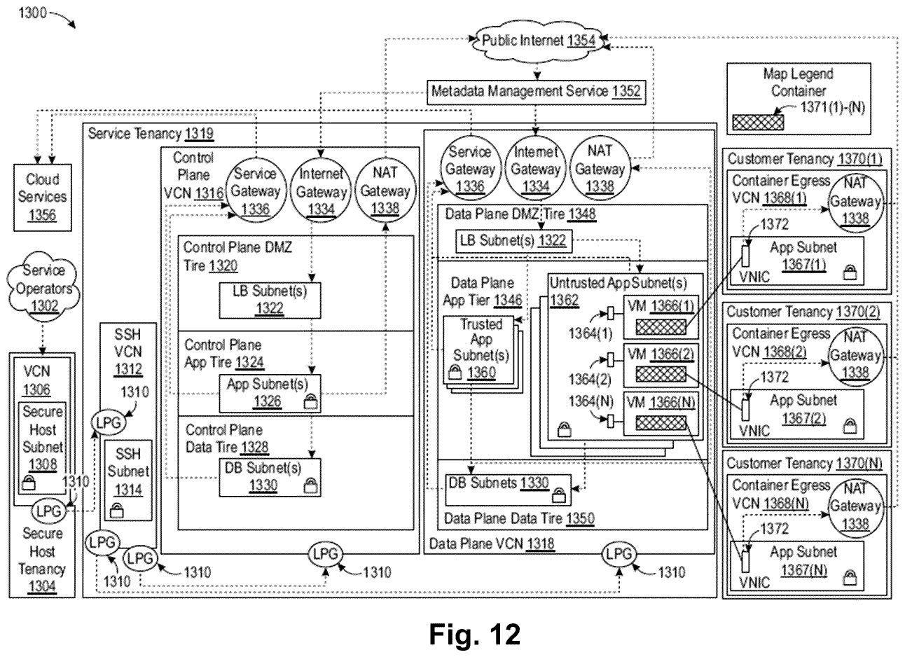

FIG. 12 is a block diagram 1300 illustrating another example pattern of an IaaS architecture, according to at least one embodiment. Service operators 1302 (e.g. service operators 1102) can be communicatively coupled to a secure host tenancy 1304 (e.g. the secure host tenancy 1104) that can include a virtual cloud network (VCN) 1306 (e.g. the VCN 1106) and a secure host subnet 1308 (e.g. the secure host subnet 1108). The VCN 1306 can include an LPG 1310 (e.g. the LPG 1110) that can be communicatively coupled to an SSH VCN 1312 (e.g. the SSH VCN 1112) via an LPG 1310 contained in the SSH VCN 1312. The SSH VCN 1312 can include an SSH subnet 1314 (e.g. the SSH subnet 1114), and the SSH VCN 1312 can be communicatively coupled to a control plane VCN 1316 (e.g. the control plane VCN 1116) via an LPG 1310 contained in the control plane VCN 1316 and to a data plane VCN 1318 (e.g. the data plane 1118) via an LPG 1310 contained in the data plane VCN 1318. The control plane VCN 1316 and the data plane VCN 1318 can be contained in a service tenancy 1319 (e.g. the service tenancy 1119).

The control plane VCN 1316 can include a control plane DMZ tier 1320 (e.g. the control plane DMZ tier 1120) that can include load balancer (“LB”) subnet(s) 1322 (e.g. LB subnet(s) 1122), a control plane app tier 1324 (e.g. the control plane app tier 1124) that can include app subnet(s) 1326 (e.g. similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g. the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g. the service gateway) and a network address translation (NAT) gateway 1338 (e.g. the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g. the data plane DMZ tier 1148), and a data plane data tier 1350 (e.g. the data plane data tier 1150 of FIG. 10). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

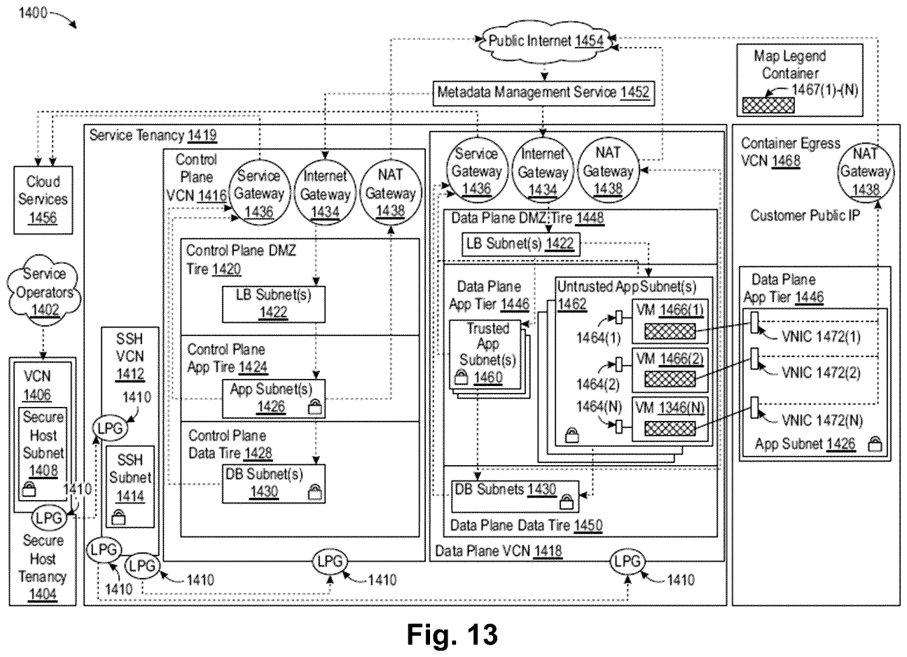

FIG. 13 is a block diagram 1400 illustrating another example pattern of an IaaS architecture, according to at least one embodiment. Service operators 1402 (e.g. service operators 1102) can be communicatively coupled to a secure host tenancy 1404 (e.g. the secure host tenancy 1104) that can include a virtual cloud network (“VCN”) 1406 (e.g. the VCN 1106) and a secure host subnet 1408 (e.g. the secure host subnet 1108). The VCN 1406 can include an LPG 1410 (e.g. the LPG 1110) that can be communicatively coupled to an SSH VCN 1412 (e.g. the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g. the control plane VCN 1116) via an LPG 1410 contained in the control plane VCN 1416 and to a data plane VCN 1418 (e.g. the data plane 1118) via an LPG 1410 contained in the data plane VCN 1418. The control plane VCN 1416 and the data plane VCN 1418 can be contained in a service tenancy 1419 (e.g. the service tenancy 1119).

The control plane VCN 1416 can include a control plane DMZ tier 1420 (e.g. the control plane DMZ tier 1120) that can include LB subnet(s) 1422 (e.g. LB subnet(s) 1122), a control plane app tier 1424 (e.g. the control plane app tier 1124) that can include app subnet(s) 1426 (e.g. app subnet(s) 1126), a control plane data tier 1428 (e.g. the control plane data tier 1128) that can include DB subnet(s) 1430 (e.g. DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway of FIG. 10) and a network address translation (NAT) gateway 1438 (e.g. the NAT gateway 1138 of FIG. 10). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 13 may be considered an exception to the pattern illustrated by the architecture of block diagram 1300 of FIG. 12 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments include a causal model of the demand-generating process which provides a representation of causal relationships involved and the functional relationship between price and demand, and an optimization problem that maximizes revenue. The statistical estimation of the demand model parameters, including the direct causal effect of price on demand, is informed by the causal structure. That estimation yields a price-demand relationship that can be used to determine the result of manipulating the price. The price-demand relationship is then embedded in the revenue maximization problem to determine the optimal set of prices. Implementing these optimal prices yields new interventional data that can be used to refine both the causal model and the statistical estimate in a reinforcement learning fashion.

The causal effect estimation is implemented in embodiments using the Double Machine Learning approach with the log-linear demand model, that is, the output variable is the logarithm of the demand. In this approach, the usual log-linear model is extended with a second model that describes price in terms of other factors. Instrumental variables are a powerful tool for causal effect estimation in the presence of confounding. As natural instruments are notoriously hard to find or engineer, Double ML provides an effective alternative by treating the price residuals as an artificial instrument. Finally, a two-stage estimation is performed.

Double ML is based on the ideas of orthogonalization and sample-splitting which allow removing regularization and overfitting biases from the treatment effect estimates in the presence of high-dimensional confounders. The basic idea is splitting the data into two samples and using the first one to fit ML models of demand and price based on the other observed factors, obtain the orthogonal residuals, and then use the second sample to calculate the treatment effect on these residuals. Embodiments also provides the methodology to account for price effect heterogeneity which allows for price differentiation.

Once the causal parameters are estimated, the resulting demand model is used to find the optimal prices. However, in order to mitigate the effect of the potential error in parameter estimation, embodiments set certain limits to the price changes. An added benefit of this approach is that new price points are created, which are used to improve the accuracy of the causal model.

In contrast to known solutions, embodiments first builds a causal model capable of separating or disentangling pricing effects from seasonality, promotion, and other effects. Second, the Double ML model is used to estimate the heterogeneous price effect. Finally, an optimization routine is used to optimize the prices based on the causal model parameters.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

1. A method of optimizing hotel room pricing, the method comprising:
generating a causal model comprising an estimate of a causal effect of a hotel room price on a demand of the hotel room and using the causal model for determining a set of features for determining hotel room pricing;
receiving historical hotel room reservation data;
selecting and training one type of predictive model from a plurality of different types of predictive models based at least on the causal model; and
mapping the price of the hotel room to the demand of the hotel room based on an output estimate from the selected type of predictive model using the historical hotel room reservation data, the selected predictive model trained with the determined set of features from the causal model.

2. The method of claim 1, further comprising:
embedding the mapping into a revenue-maximizing optimization problem and determining an optimal set of prices.

3. The method of claim 2, further comprising:
providing the optimal set of prices as selectable prices in a user interface; and
receiving a selection of one of the optimal set of prices in connection with a hotel room reservation selection.

4. The method of claim 3, further comprising:
in response to the selection, refining and retraining the causal model and the predictive model.

5. The method of claim 1, wherein the plurality of different types of predictive models comprise a linear regression model, a random forest model, and a double ML model.

6. The method of claim 2, wherein the optimal prices comprise optimal prices for a plurality of classes of hotel rooms.

7. The method of claim 1, wherein using the causal model for determining a set of features for determining hotel room pricing comprises:
blocking all non-causal flow of information by controlling for appropriate variables to identify confounders;
adjusting for each level of the identified confounders automatically by fitting a regression hyperplane on a price and a corresponding identified confounder.

8. (canceled)

9. A non-transitory computer readable medium having instructions stored thereon that, when executed by one or more processors, cause the processor to optimize hotel room pricing, the optimizing comprising:
generating a causal model comprising an estimate of a causal effect of a hotel room price on a demand of the hotel room and using the causal model for determining a set of features for determining hotel room pricing;
receiving historical hotel room reservation data;
selecting and training one type of predictive model from a plurality of different types of predictive models based at least on the causal model; and
mapping the price of the hotel room to the demand of the hotel room based on an output estimate from the selected type of predictive model using the historical hotel room reservation data, the selected predictive model trained with the determined set of features from the causal model.

10. The computer readable medium of claim 9, the optimizing further comprising:
embedding the mapping into a revenue-maximizing optimization problem and determining an optimal set of prices.

11. The computer readable medium of claim 10, the optimizing further comprising:
providing the optimal set of prices as selectable prices in a user interface; and
receiving a selection of one of the optimal set of prices in connection with a hotel room reservation selection.

12. The computer readable medium of claim 11, the optimizing further comprising:
in response to the selection, refining and retraining the causal model and the predictive model.

13. The computer readable medium of claim 9, wherein the plurality of different types of predictive models comprise a linear regression model, a random forest model, and a double ML model.

14. The computer readable medium of claim 10, wherein the optimal prices comprise optimal prices for a plurality of classes of hotel rooms.

15. The computer readable medium of claim 9, wherein using the causal model for determining a set of features for determining hotel room pricing comprises:
blocking all non-causal flow of information by controlling for appropriate variables to identify confounders;
adjusting for each level of the identified confounders automatically by fitting a regression hyperplane on a price and a corresponding identified confounder.

16. (canceled)

17. A hotel room price optimization system comprising:
a causal model comprising an estimate of a causal effect of a hotel room price on a demand of the hotel room;
a plurality of different types of predictive models;
one or more processors adapted to:
us the causal model for determining a set of features for determining hotel room pricing;
receive historical hotel room reservation data;
select and train one of the plurality of different types of predictive models based at least on the causal model; and
map the price of the hotel room to the demand of the hotel room based on an output estimate from the selected type of predictive model using the historical hotel room reservation data, the selected predictive model trained with the determined set of features from the causal model.

18. The system of claim 17, the processors further adapted to:
embed the mapping into a revenue-maximizing optimization problem and determining an optimal set of prices.

19. (canceled)

20. The system of claim 17, the processors further adapted to:
in response to the selection, refine and retrain the causal model and the predictive model.

21. The method of claim 1, wherein the optimizing hotel room pricing comprises using a cloud infrastructure comprising:
a first virtual cloud network (VCN) comprising a local peering gateway (LPG) communicatively coupled to a secure shell (SSH) VCN via the LPG;
wherein the LPG is contained in a control plane VCN and the SSH VCN is communicatively coupled to a data plane VCN.

22. The computer readable medium of claim 9, wherein the optimizing hotel room pricing comprises using a cloud infrastructure comprising:
a first virtual cloud network (VCN) comprising a local peering gateway (LPG) communicatively coupled to a secure shell (SSH) VCN via the LPG;
wherein the LPG is contained in a control plane VCN and the SSH VCN is communicatively coupled to a data plane VCN.

23. The system of claim 17, wherein the system is implemented in by cloud infrastructure comprising:
a first virtual cloud network (VCN) comprising a local peering gateway (LPG) communicatively coupled to a secure shell (SSH) VCN via the LPG;
wherein the LPG is contained in a control plane VCN and the SSH VCN is communicatively coupled to a data plane VCN.
